(19) United States
(12) Patent Application Publication
(10) Pub. No.: US 2026/0320746 A1
(43) Pub. Date: Oct. 15, 2026

(54) ROBUST AND ACCURATE ANOMALY DETECTION IN VISUAL INSPECTION

(71) Applicant: International Business Machines Corporation, Armonk, NY (US)

(72) Inventors: Ioana Giurgiu, Zürich (CH); Daniel Yang, Herrenberg (DE); Daniel Justin Caraballo Rivera, Villebon-sur-Yvette (FR); Adelmo Cristiano Innocenza Malossi, Schönenberg (CH)

(21) Appl. No.: 19/180,104

(22) Filed: Apr. 15, 2025

(51) Int. Cl. G06T 5/50; G06T 3/40; G06T 7/11; G06T 7/194

(52) U.S. Cl. CPC G06T 5/50; G06T 3/40; G06T 7/11; G06T 7/194; G06T 2207/20081

(57) ABSTRACT

Visual prompting is performed to isolate an object of interest in an original image to generate a pre-processed image. A score map is generated by processing the pre-processed image with a masked multi-scale reconstruction model. Unnecessary background content is removed from at least one selected from the group consisting of the pre-processed image and the score map. A Region Intersection-over-Union threshold is applied to the generated score map to perform anomaly localization and superimposing the score map on the original image. At least one action on a physical component corresponding to the original image is facilitated based on the superimposed image.

### BACKGROUND

The present invention relates generally to the electrical, electronic and computer arts and, more particularly, to machine learning.

Anomaly detection in visual inspection focuses on identifying and localizing defects in industrial processes. Defects can vary from subtle changes like thin scratches to larger structural ones like missing components. Such detection is advantageous in smart manufacturing, automated maintenance, automated visual inspection, and the like.

### BRIEF SUMMARY

Principles of the invention provide systems and techniques for robust and accurate anomaly detection in visual inspection. In one aspect, an exemplary method includes the operations of performing visual prompting to isolate an object of interest in an original image to generate a pre-processed image; generating a score map by processing the pre-processed image with a masked multi-scale reconstruction model; removing unnecessary background content from at least one location selected from the group consisting of the pre-processed image and the score map; applying a Region Intersection-over-Union threshold to the generated score map to perform anomaly localization and superimposing the score map on the original image; and facilitating at least one action on a physical component corresponding to the original image based on the superimposed image.

In one aspect, a computer program product comprises one or more tangible computer-readable storage media and program instructions stored on at least one of the one or more tangible computer-readable storage media, the program instructions executable by a processor, the program instructions comprising performing visual prompting to isolate an object of interest in an original image to generate a pre-processed image; generating a score map by processing the pre-processed image with a masked multi-scale reconstruction model; removing unnecessary background content from at least one location selected from the group consisting of the pre-processed image and the score map; applying a Region Intersection-over-Union threshold to the generated score map to perform anomaly localization and superimposing the score map on the original image; and facilitating at least one action on a physical component corresponding to the original image based on the superimposed image.

In one aspect, an apparatus comprises a memory and at least one processor, coupled to the memory, and operative to perform operations comprising performing visual prompting to isolate an object of interest in an original image to generate a pre-processed image; generating a score map by processing the pre-processed image with a masked multi-scale reconstruction model; removing unnecessary background content from at least one location selected from the group consisting of the pre-processed image and the score map; applying a Region Intersection-over-Union threshold to the generated score map to perform anomaly localization and superimposing the score map on the original image; and facilitating at least one action on a physical component corresponding to the original image based on the superimposed image.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A illustrates an example of visual inspection, in accordance with exemplary embodiments;

FIG. 1B is a block diagram of an example system for anomaly detection in images, in accordance with example embodiments;

FIG. 2A is a summary of pinboards and PCI card datasets, in accordance with example embodiments;

FIG. 2B is a table describing evaluation of a conventional anomaly detection technique vs. disclosed framework, in accordance with example embodiments; and

FIG. 3 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), in aspects of the invention a method comprises performing visual prompting to isolate an object of interest in an original image 212 to generate a pre-processed image; generating a score map by processing the pre-processed image with a masked multi-scale reconstruction model 244; removing unnecessary background content from at least one location selected from the group consisting of the pre-processed image and the score map; applying a Region Intersection-over-Union threshold 252 to the generated score map to perform anomaly localization 256 and superimposing the score map on the original image 212; and facilitating at least one action on a physical component corresponding to the original image 212 based on the superimposed image. Technical benefits include improvements to the technical process of computer-aided parts inspection by enabling the identification of small defects.

In exemplary embodiments, the Region Intersection-over-Union threshold 252 is selected, wherein the Region Intersection-over-Union threshold 252 maximizes a Region Intersection-over-Union. Technical benefits include automatic thresholding to determine the threshold which maximizes the intersection of union (IoU) curve, thus relieving the user of this decision.

In exemplary embodiments, the removing of the unnecessary background content is performed on the generated score map. Technical benefits include the handling of high resolution images with tiling support, especially important when defects are extremely small (for example, as small as a couple of pixels). (The model will have learned the background information so that image edges may be handled better at locations where the background is cut out.)

In exemplary embodiments, the removing of the unnecessary background content is performed on the pre-processed image. Technical benefits include the handling of high resolution images with tiling support, a simpler image to train on and process (resulting in faster processing) and the removal of the “noise” contributed by the background which can drown out defects that are extremely small.

In exemplary embodiments, the masked multi-scale reconstruction model 244 is trained to generate the score map. Technical benefits include reducing the amount of training since the MMR 244 is pretrained and the MMR 244 is robust to domain shifts and variations.

In exemplary embodiments, the original image 212 is tiled prior to the generation of the score map. Technical benefits include the handling of high resolution images with tiling support, especially important when defects are extremely small, and maintaining the original image resolution.

In exemplary embodiments, the action is selected from the group consisting of accepting the physical component, rejecting the physical component, and reworking the physical component. Technical benefits include improvements to the technical process of computer-aided parts inspection by enabling the identification of small defects.

In exemplary embodiments, the unnecessary background content is background content that confuses detection models. Technical benefits include eliminating areas of the image 212 that would impair the detection of defects.

In exemplary embodiments, the original image 212 is downscaled. Technical benefits include the ability to use lower performance hardware and/or software resources to perform the inspection.

In exemplary embodiments, the downscaled image is tiled into manageable sizes following the downscaling of the original image 212. Technical benefits include the handling of high resolution images with tiling support, especially important when defects are extremely small.

In exemplary embodiments, the masked multi-scale reconstruction model 244 is part of a pipeline configured to divide the original image 212 into a plurality of patches; mask a given percentage of the plurality of patches and preserve a remaining percentage of the plurality of patches; feed the preserved patches into a visual transformer pre-trained by masked auto encoding, which generates embeddings of the patches; append the embeddings of the masked patches to the embeddings of the preserved patches; and generate, using feature pyramid network (FPN), multi-scale features from the embeddings. Technical benefits include reducing the amount of training since the MMR 244 is pretrained and the MMR 244 is robust to domain shifts and variations.

In one aspect, a computer program product comprises one or more tangible computer-readable storage media and program instructions stored on at least one of the one or more tangible computer-readable storage media, the program instructions executable by a processor, the program instructions comprising performing visual prompting to isolate an object of interest in an original image 212 to generate a pre-processed image; generating a score map by processing the pre-processed image with a masked multi-scale reconstruction model 244; removing unnecessary background content from at least one location selected from the group consisting of the pre-processed image and the score map; applying a Region Intersection-over-Union threshold 252 to the generated score map to perform anomaly localization 256 and superimposing the score map on the original image 212; and facilitating at least one action on a physical component corresponding to the original image 212 based on the superimposed image.

In one aspect, an apparatus comprises a memory and at least one processor, coupled to the memory, and operative to perform operations comprising performing visual prompting to isolate an object of interest in an original image 212 to generate a pre-processed image; generating a score map by processing the pre-processed image with a masked multi-scale reconstruction model 244; removing unnecessary background content from at least one location selected from the group consisting of the pre-processed image and the score map; applying a Region Intersection-over-Union threshold 252 to the generated score map to perform anomaly localization 256 and superimposing the score map on the original image 212; and facilitating at least one action on a physical component corresponding to the original image 212 based on the superimposed image.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
an anomaly detection framework that:
1) handles high resolution images with tiling support, especially important when defects are extremely small (for example, as small as a couple of pixels);
2) requires only a few dozens of normal samples to train on;
3) is robust to domain shifts and variations; and
4) uses automatic thresholding to determine the threshold which maximizes the intersection of union (IoU) curve, thus relieving the user of this decision.

Anomaly detection and localization is significant for automating visual inspection. Conventional approaches are sensitive to domain shifts, cannot handle high resolution images, and severely underperform in a low data regime. In example embodiments, an end-to-end framework based on masked multi-scale reconstruction for anomaly detection is enhanced with visual prompting and automatic thresholding. The framework is shown to achieve excellent performance on real industrial scenarios, even when only a few dozen samples are available for training. The application of this framework was demonstrated along with an intuitive, interactive interface which can be easily used by users, such as domain experts.

### Introduction

Since it is generally difficult to collect enough abnormal samples during industrial processes, anomaly detection is typically conducted in a one-class learning setting, where only normal samples are used for training. The hope is that defects appear with a significantly different distribution during inference. Conventional approaches have been shown to perform well on public benchmarks. These benchmarks contain only low-resolution samples (e.g., 256×256 pixels) and are built on the premise of sample alignment and consistent scales within each class. In real inspection scenarios, however, significant variations in object scale and viewpoint can be observed, and captured images are typically of high resolution (e.g., 3k×5k pixels). In fact, conventional methods have been shown to exhibit a heightened sensitivity to slight variations in the data distribution, which have led to high rates of false positives and failures to detect genuine defects. Their training also requires thousands of samples, which is difficult to accommodate for in industrial applications where usually only a handful of samples are typically available. Finally, manual thresholds are used to determine whether an anomaly is present or not, putting the burden on the user to select appropriate values.

In example embodiments, an anomaly detection framework enhanced with visual prompting (VP) is introduced that is accurate in identifying and localizing defects for real inspection scenarios, and under all the constraints that come with such scenarios. Specifically, the anomaly detection framework: 1) handles high resolution images with tiling support, especially important when defects are extremely small (for example, as small as a couple of pixels); 2) requires only a few dozen normal samples to train on; 3) is robust to domain shifts and variations; and 4) uses automatic thresholding that maximizes the IoU curve, thus relieving the user of this decision.

An exemplary system was evaluated against the conventional anomaly detection technique on two industrial use cases and shows that it achieves significantly better accuracy. How a user, such as a domain expert, can train, deploy and export models, as well as inspect the detected anomalies, all through an intuitive interface is described below.

Framework

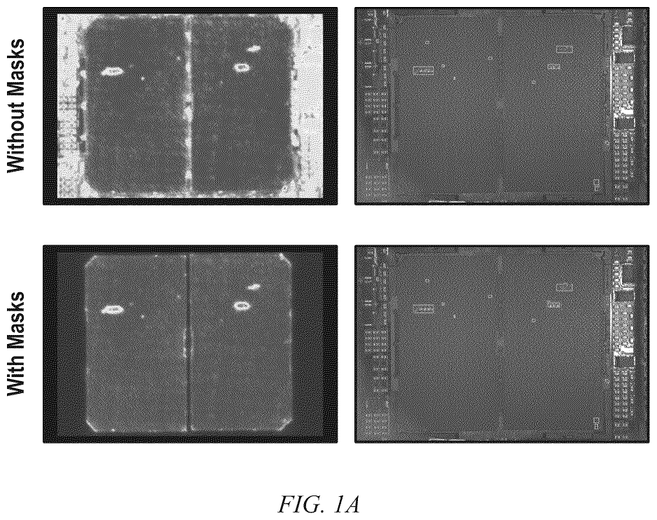

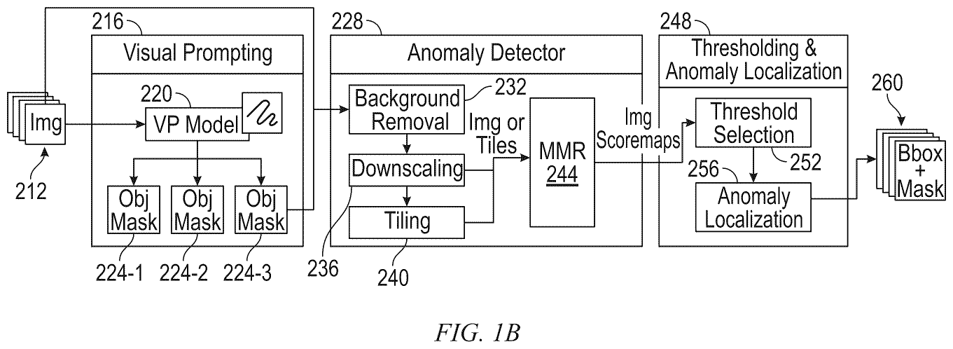

In most industrial use cases, the object of interest for anomaly detection represents only a part of the image sample, while the rest is merely background. However, this background may contain various objects and numerous variations which can confuse the most accurate and robust anomaly detectors, especially when trained on only a handful of samples. FIG. 1A illustrates an example of visual inspection, in accordance with exemplary embodiments. The image in the upper-left corner shows a pinboard component without the use of masks and the image in the upper-right corner shows the final pinboard component image generated without the use of masks. The image in the lower-left corner shows a component with the use of masks and the image in the lower-right corner shows the final pinboard component image generated with the use of masks. The use of masks effectively increases the number of true positives and reduces the number of false positives.

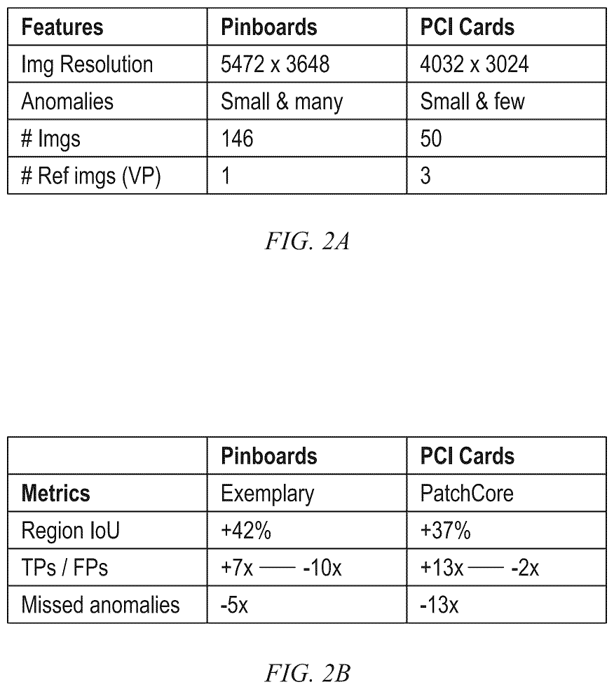

FIG. 1B is a block diagram of an example system for anomaly detection in images, in accordance with example embodiments. The disclosed framework includes several stages: 1) background removal 232 around the object of interest via VP; 2) downscaling 236 and tiling 240 (applied only to high resolution images 212); 3) anomaly detection 228 with domain shift; and, finally, 4) automatic threshold selection 252 on output heatmaps to generate masks and bounding boxes localizing the detected defects. An example of the inputs, score maps, and outputs for the example system is illustrated in FIGS. 2A-2B.

### Visual Prompting

In order to isolate the foreground object from the background, a conventional training-free “visual prompting” (VP) approach 216 that uses combinations of powerful vision foundation models is used to perform open-world segmentation of objects given a few reference samples annotated with user scribbles. In particular, the exemplary algorithm adapts a conventional architecture to stricter latency requirements by making it more scalable using several exemplary techniques. The exemplary visual prompting workflow 216 first uses the conventional model (in a non-limiting example, the segment anything (SAM) segmentation model) to recover segmentation masks of scribbled reference objects which, in a second step, are featurized through a conventional pretrained vision backbone and matched to featurized patches of the target images 212. While other conventional techniques perform this operation with Hungarian bi-partite matching, a faster and more scalable approach that results in a probability map over a target image 212 obtained by aggregating and soft-maxing a sequence of cosine similarity matrices between reference and target features is utilized. A set of pixels on each target image 212 are then sampled from the computed probability maps and, in a last step, are used again as sparse prompts for SAM, which thereby allows segmented objects on the target images 212 to be recovered.

A pertinent advantage of using VP models 220 versus traditional instance segmentation models is the low-cost barrier in providing annotations for training. Typically, at most five reference images 212 are needed to be scribbled on, as opposed to hundreds or thousands of samples, for which detailed polygons need to be manually drawn.

### Anomaly Detection Model

Next, the newly generated samples from the visual prompting 216 are cropped tight around the object of interest. If the resulting bounding box is still high resolution (i.e., greater than, for example, 1024×1024 pixels), downscaling 236 by a factor (e.g., 2) and, potentially, tiling 240 are applied, such that samples of size 512×512 pixels are used for the actual anomaly detection task.

Masked multiscale reconstruction (MMR) 244 is used for anomaly detection 228 since it is robust to domain shifts, such as changes in illumination and view. The exemplary MMR pipeline includes two parts. In the first part, the sample image 212 is evenly divided into several patches, and a certain percentage of these patches (set at 0.4) are masked while others are preserved, where the patches have equal height and width. The preserved patches are fed into a visual transformer, such as ViT-B, pre-trained by masked auto encoding (MAE), which generates embeddings of these patches. The random initialized embeddings of the masked patches are then appended to the embeddings of the preserved patches. A simple feature pyramid network (FPN) is used to take the embeddings of all patches as input and generate multi-scale features. In the second part, a frozen pre-trained hierarchical encoder, implemented by a wide residual network, such as WideResNet50, is used to encode the same input used in the first part into multi-scale features. A goal of the model 220 in one or more embodiments is to align the multi-scale features produced by the two parts. The underlying motivation for recovering the information on the masked patches is that it is hoped that the model 220 can perceive the dependence of spatial positions of different parts in the images 212. The reconstruction task is responsible for focusing on the details, while the masked recovery task is for the causality of various parts. (The skilled artisan would be familiar with ViT-B, MAE, FPN and WideResNet50 and, given the teachings herein, can utilize same or other approaches to implement aspects of the invention.)

The output of the anomaly detector 228 is an anomaly score map, obtained by minimizing the multi-scale reconstruction loss between the FPN and the frozen hierarchical encoder. If tiling 240 was applied as a pre-processing step, then all tile score maps are combined by using linear blending into an overall image score map. Finally, this score map is up-sampled to the original image size by using bilinear interpolation. (It is noted that MMR 244 is trained on normal samples, while at inference it is expected that a mix of images 212 with defects and normal ones will be input.)

### Automatic Thresholding and Defect Localization

Finally, while score maps are intuitive to interpret, since anomalies are shown as hotspot regions, real use case scenarios will benefit from clear anomaly identification and localization. The first depends on thresholding 252. State of the art methods pay little attention to this aspect, rather leaving the decision to choose a (manual) threshold to the user. This is by far not optimal and usually involves a game of trial-and-error to find a threshold that maximizes the true positive/false positive (TP/FP) rate. One focus is automating this process by determining at inference which threshold value maximizes Region IoU and simultaneously ensures that the FP rate is not high. An equal weight is also put on large and small anomalies, to ensure small anomalies are still caught by the model 220. The second implies that the thresholded score map is converted into a binary mask, connected components are computed on this mask and then bounding boxes are generated for each connected component. In the end, these bounding boxes are presented to the user as the localized anomalous regions.

Returning to FIG. 1, training-free visual prompting 216 is performed to isolate the foreground object from the background. As described above, the visual prompting 216 uses combinations of powerful vision foundation models to perform open-world segmentation of objects given a few reference samples annotated with user scribbles (the process of highlighting an area of interest, such as using points, lines, shapes and the like). The visual prompting 216 first uses the SAM segmentation model to recover segmentation masks of scribbled reference objects which, in a second step, are featurized through a pretrained vision backbone and matched to featurized patches of the target images 212. A faster and more scalable approach that results in a probability map over a target image 212 obtained by aggregating and soft-maxing a sequence of cosine similarity matrices between reference and target features is utilized. A set of pixels on each target image 212 are then sampled from the computed probability maps and, in a last step, are used again as sparse prompts for SAM, which thereby allows segmented objects on the target images 212 to be recovered.

In example embodiments, the newly generated samples from the visual prompting 216 are cropped tight around the object of interest. If the resulting bounding box is still high resolution, downscaling 236 by a factor (e.g., 2), applying tiling 240 (such that samples of size 512×512 pixels are used for the actual anomaly detection task) or both downscaling 236 and tiling 240. The downscaling and tiling are dependent on user preferences. (Not using downscaling may, however, preserve image details.) Tiling is appropriate when the input image is of high resolution since, for example, graphical processing units (GPUs) operate with limited video memory. Therefore, tiling may be performed to both preserve the image features without downscaling, and to reduce the size of the image that is processed by the model. In general, as noted above, downscaling, tiling or both may be applied. Note also that, given the teachings herein, the skilled artisan will be able to readily determine appropriate threshold(s) to implement thresholding using heuristics as appropriate for the given domain/application.

MMR 244 is used for anomaly detection 228. The output of the anomaly detector 228 is an anomaly score map, obtained by minimizing the multi-scale reconstruction loss between the FPN and the frozen hierarchical encoder. If tiling 240 was applied as a pre-processing step, then all tile score maps are combined, by using linear blending, into an overall image score map. Finally, this score map is up-sampled to the original image size by using bilinear interpolation.

In example embodiments, clear anomaly identification depends on thresholding 252. Thresholding 252 is automated by determining at inference which threshold value maximizes Region IoU and simultaneously ensures that the FP rate is not high. An equal weight is also put on large and small anomalies, to ensure small anomalies are still caught by the model 220. The second implies that the thresholded score map is converted into a binary mask, connected components are computed on this mask. and then bounding boxes 260 are generated for each connected component. In the end, these bounding boxes 260 are generated by the thresholding and anomaly localization 248 and are presented to the user as the localized anomalous regions.

### Evaluation on Real Use Cases

An exemplary framework according to aspects of the invention is evaluated against the conventional anomaly detection technique on two real use cases: peripheral component interconnect (PCI) cards and pinboards. A few relevant characteristics of their datasets are summarized in the table of FIG. 2A. While they differ in the volume of expected anomalies, the datasets are very small and the user has to scribble on at most three images 212 to obtain high quality masks 224-1, 224-2, 224-3, such as the ones shown in FIG. 1A.

Relative results on Region IoU, TP, FP and missed defects when the exemplary system is compared to the conventional anomaly detection technique are shown in the table FIG. 2B. Notably, the conventional anomaly detection technique receives as inputs tightly cropped bounding boxes around the objects of interest, and downscales them to 256×256 pixels prior to feeding them into the backbone. The exemplary framework increases Region IoU by 37-42% and TPs by 13×. In both, a reduction in FPs is seen. Additionally, the number of missed anomalies reduces by up to 13×. Upon further inspection, using VP in the pipeline is shown to have a particularly positive effect in boosting Region IoU by 14-19% and reducing FPs.

Interactive Aspects

A visual inspection framework supporting anomaly detection for industrial use cases has been developed. This allows a user to upload datasets for training (only normal samples) and testing/inference (a mix of normal and anomalous samples).

In non-limiting example embodiments, at training, the user will connect to an external service providing the VP capability. Once there, k samples are selected by the user to scribble on, marking the object of interest (i.e., k is arbitrarily chosen by the user, but typically at most five samples are enough for an accurate output mask). Then, the VP model 220 will be seamlessly trained and object masks 224-1, 224-2, 224-3 will be detected for the entire training set. In the next step, and without any user intervention, the visual inspection framework will use the masks 224-1, 224-2, 224-3 to replace the background of the original samples in the training set with a uniform background, and thus generate new samples. Then, it will downscale and tile, as necessary. When these pre-processing steps are completed, the user will be allowed to train an anomaly detection model 220. While various knobs for training can be provided, such as adjusting learning rates, maximum number of epochs, and so on, the framework is also aimed at domain experts that are typically not familiar with the intricacies of artificial intelligence (AI) models. When training is finished, the trained model will be found in a list of existing models, which the user can decide to deploy in the future.

In example embodiments, at deployment, the user selects the desired model from the list of trained models and can deploy, as well as export, the model locally. Deployment is possible if an existing dataset for inference has been uploaded and linked to the model. The VP service will be called to run inference on the test set and will return the masks 224-1, 224-2, 224-3, followed by the background removal step, down-sampling, and tiling steps. Once the anomaly detection is run, transparent to the user, the threshold selection 252 and anomaly localization 256 will take place. Finally, the user can check all samples in the test set for the detected anomalies. For each sample, the user will visualize the bounding boxes surrounding the detected defects and associated confidence scores.

### Demonstration

FIG. 2A is a summary of pinboards and PCI card datasets, in accordance with example embodiments. As illustrated in FIG. 2A, very few reference images are needed for training the system and to process significantly more high resolution images. FIG. 2B is a table describing evaluation of the conventional anomaly detection technique vs. an exemplary framework, in accordance with example embodiments. As illustrated in FIG. 2A, the exemplary framework results in a significant improvement of IoU and True positive detections.

The interactive framework was demonstrated using industrial datasets, enabling users to act as domain experts. Users can upload various datasets, mark the object of interest for the anomaly detection task by scribbling on a few images 212. They can also train, deploy and export models, and inspect the detected defects.

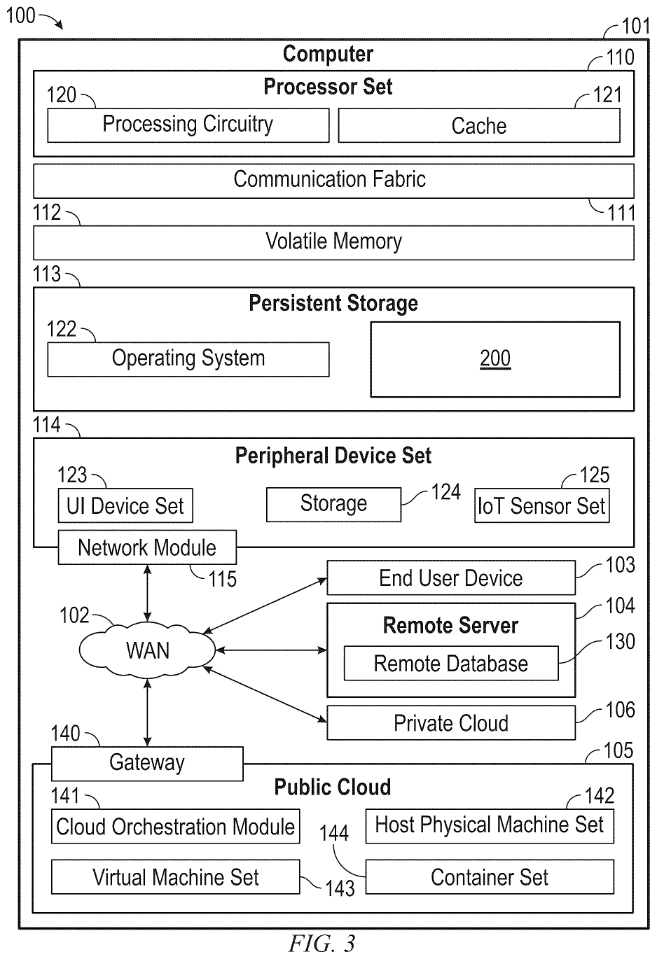

Refer now to FIG. 3.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as image processing system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 3. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
performing visual prompting to isolate an object of interest in an original image to generate a pre-processed image;
generating a score map by processing the pre-processed image with a masked multi-scale reconstruction model;
removing unnecessary background content from at least one location selected from the group consisting of the pre-processed image and the score map;
applying a Region Intersection-over-Union threshold to the generated score map to perform anomaly localization and superimposing the score map on the original image; and
facilitating at least one action on a physical component corresponding to the original image based on the superimposed image.

2. The method of claim 1, further comprising selecting the Region Intersection-over-Union threshold, wherein the Region Intersection-over-Union threshold maximizes a Region Intersection-over-Union.

3. The method of claim 1, wherein the removing of the unnecessary background content is performed on the generated score map.

4. The method of claim 1, wherein the removing of the unnecessary background content is performed on the pre-processed image.

5. The method of claim 1, further comprising training the masked multi-scale reconstruction model to generate the score map.

6. The method of claim 1, further comprising tiling the original image prior to the generating of the score map.

7. The method of claim 1, wherein the action is selected from the group consisting of accepting the physical component, rejecting the physical component, and reworking the physical component.

8. The method of claim 1, wherein the unnecessary background content is background content that confuses detection models.

9. The method of claim 1, further comprising downscaling the original image.

10. The method of claim 9, further comprising tiling the downscaled image into manageable sizes following the downscaling of the original image.

11. The method of claim 1, wherein the masked multi-scale reconstruction model is part of a pipeline configured to:
divide the original image into a plurality of patches;
mask a given percentage of the plurality of patches and preserve a remaining percentage of the plurality of patches;
feed the preserved patches into a visual transformer pre-trained by masked auto encoding, which generates embeddings of the patches;
append the embeddings of the masked patches to the embeddings of the preserved patches; and
generate, using feature pyramid network (FPN), multi-scale features from the embeddings.

12. A computer program product, comprising:
one or more tangible computer-readable storage media and program instructions stored on at least one of the one or more tangible computer-readable storage media, the program instructions executable by a processor, the program instructions comprising:
performing visual prompting to isolate an object of interest in an original image to generate a pre-processed image;
generating a score map by processing the pre-processed image with a masked multi-scale reconstruction model;
removing unnecessary background content from at least one location selected from the group consisting of the pre-processed image and the score map;
applying a Region Intersection-over-Union threshold to the generated score map to perform anomaly localization and superimposing the score map on the original image; and
facilitating at least one action on a physical component corresponding to the original image based on the superimposed image.

13. A system comprising:
a memory; and
at least one processor, coupled to said memory, and operative to perform operations comprising:
performing visual prompting to isolate an object of interest in an original image to generate a pre-processed image;
generating a score map by processing the pre-processed image with a masked multi-scale reconstruction model;
removing unnecessary background content from at least one location selected from the group consisting of the pre-processed image and the score map;
applying a Region Intersection-over-Union threshold to the generated score map to perform anomaly localization and superimposing the score map on the original image; and
facilitating at least one action on a physical component corresponding to the original image based on the superimposed image.

14. The system of claim 13, the operations further comprising selecting the Region Intersection-over-Union threshold, wherein the Region Intersection-over-Union threshold maximizes a Region Intersection-over-Union.

15. The system of claim 13, the operations further comprising training the masked multi-scale reconstruction model to generate the score map.

16. The system of claim 13, the operations further comprising tiling the original image prior to the generating of the score map.

17. The system of claim 13, wherein the action is selected from the group consisting of accepting the physical component, rejecting the physical component, and reworking the physical component.

18. The system of claim 13, the operations further comprising downscaling the original image.

19. The system of claim 18, the operations further comprising tiling the downscaled image into manageable sizes following the downscaling of the original image.

20. The system of claim 13, wherein the masked multi-scale reconstruction model is part of a pipeline configured to:
divide the original image into a plurality of patches;
mask a given percentage of the plurality of patches and preserve a remaining percentage of the plurality of patches;
feed the preserved patches into a visual transformer pre-trained by masked auto encoding, which generates embeddings of the patches;
append the embeddings of the masked patches to the embeddings of the preserved patches; and
generate, using feature pyramid network (FPN), multi-scale features from the embeddings.
